(19) United States
(12) Patent Application Publication
(10) Pub. No.: US 2017/0182813 A1
(43) Pub. Date: Jun. 29, 2017

(54) PRINTER

(71) Applicant: SEIKO EPSON CORPORATION, Tokyo (JP)

(72) Inventors: Hidenao SUZUKI, Matsumoto-shi (JP); Naomi KIMURA, Okaya-shi (JP); Koji KAWAI, Shiojiri-Shi (JP); Shoma KUDO, Shiojiri-Shi (JP); Takanori MATSUDA, Shiojiri-Shi (JP)

(21) Appl. No.: 15/378,766

(22) Filed: Dec. 14, 2016

(30) Foreign Application Priority Data
Dec. 24, 2015 (JP) 2015-251077

(51) Int. Cl. B41J 25/00; B41J 2/01

(52) U.S. Cl. CPC B41J 25/006; B41J 2/01

(57) ABSTRACT

A printer includes a printing unit including a printing head configured to eject ink onto a sheet and a sheet ejecting portion configured to eject the sheet after the printing head performs a printing operation, a scanner unit located above the printing unit and configured to read an image on a document, and a tank unit located on a lateral side of the printing unit. The tank unit includes a tank storing the ink to be supplied to the printing head and a housing covering the tank. The housing provides at least a front surface, a lateral surface, a rear surface, and an upper surface of the tank unit. A front surface of the printing unit is flush with the front surface of the tank unit when the printing unit has a front surface on a side of the sheet ejecting portion.

### BACKGROUND

1. Technical Field

The present invention relates to printers, for example.

2. Related Art

An ink jet printer is widely known as an example of a printer. The ink jet printer perform a printing operation on a printing medium by ejecting ink from the printing head onto the printing medium such as a print sheet. In a well-known configuration of the ink jet printer, the ink is supplied from the tank unit to the ejection head (for example, JP-A-2015-163462). JP-A-2015-163462 discloses a tank unit including a tank having a fill port and a cover pivotally movable between a closed position and an open position. The cover at the closed position covers the fill port and the cover at the open position uncovers the fill port.

In the printer described in JP-A-2015-163462, the tank unit is disposed on a lateral side of the ink jet printer. In this printer, the tank unit protrudes outward from the ink jet printer, and thus the ink jet printer has unevenness in the external appearance. This causes the ink jet printer to readily come in contact with the surroundings during transportation of the ink jet printer, for example. In addition, the size of the tank unit may be increased in the width direction (direction from the ink jet printer toward the tank unit) to increase the ink capacity of the tank unit. This makes the unevenness in the external appearance of the ink jet printer more recognizable. In addition, the increase in the size of the tank unit in the width direction increases the overall size of the printer.

### SUMMARY

An advantage of some aspects of the invention is that the above-described problems are at least solved. The aspects of the invention may be embodied as the following embodiment or examples.

### EXAMPLE 1

A printer includes a printing unit including a printing head configured to eject ink onto a sheet and a sheet ejecting portion configured to eject the sheet after the printing head performs a printing operation, a scanner unit located above the printing unit and configured to read an image on a document, and a tank unit located on a lateral side of the printing unit. The tank unit includes a tank storing the ink to be supplied to the printing head and a housing covering the tank. The housing provides at least a front surface, a lateral surface, a rear surface, and an upper surface of the tank unit. A front surface of the printing unit is flush with the front surface of the tank unit when the printing unit includes the front surface on a side of the sheet ejecting portion.

In this printer, the front surface of the printing unit is flush with the front surface of the tank unit. This configuration reduces unevenness in the external appearance of the printer, reducing the possibility that the printer will come in contact with the surroundings during transportation of the printer, for example.

### EXAMPLE 2

A printer includes a printing unit including a printing head configured to eject ink onto a sheet and a sheet ejecting portion configured to eject the sheet after the printing head performs a printing operation, a scanner unit located above the printing unit and configured to read an image on a document, and a tank unit located on a lateral side of the printing unit. The tank unit includes a tank storing the ink to be supplied to the printing head and a housing covering the tank. The housing provides at least a front surface, a lateral surface, a rear surface, and an upper surface of the tank unit. A rear surface of the printing unit is flush with the rear surface of the tank unit when the printing unit includes a front surface on a side of the sheet ejecting portion.

In this printer, the rear surface of the printing unit is flush with the rear surface of the tank unit. This configuration reduces unevenness in the external appearance of the printer, reducing the possibility that the printer will come in contact with the surroundings during transportation of the printer, for example.

### EXAMPLE 3

A printer includes a printing unit including a printing head, a scanner unit located above the printing unit and configured to read an image on a document, and a tank unit located on a lateral side of the printing unit. The tank unit includes a tank storing the ink to be supplied to the printing head and a housing covering the tank. The housing provides at least a front surface, a lateral surface, a rear surface, and an upper surface of the tank unit. The upper surface of the tank unit is located above the printing unit when the printer is in an operable position allowing the printing unit to be operated.

In this printer, the upper surface of the tank unit is located above the printing unit when the printer is in the operable position. This configuration reduces unevenness in the external appearance of the printer, reducing the possibility that the printer will come in contact with the surroundings during transportation, for example. In addition, in this printer, an ink capacity of the tank unit is increased by increasing the size of the tank unit in an upper direction. This reduces an increase in the size of the printer in the lateral direction.

### EXAMPLE 4

In the printer according to the above-described examples, the scanner unit may have a document mounting surface on which the document is mounted. The upper surface of the tank unit may be substantially level with the document mounting surface when the printer is in the operable position.

### EXAMPLE 5

In the printer according to the above-described examples, the printing unit may include a supply opening on an upper surface of the printing unit and a cover covering the supply opening. A medium to be printed is supplied through the supply opening. The upper surface of the tank unit may be substantially level with the cover when the printer is in the operable position.

### EXAMPLE 6

In the printer according to the above-described examples, the tank may include a fill port through which the ink is poured into the tank.

In such a printer, the fill port allows the ink to be poured into the tank.

### EXAMPLE 7

In the printer according to the above-described examples, the housing may include a body covering a portion of the tank other than the fill port and a cover configured to be pivotally opened or closed with respect to the body. The fill port is exposed when the cover is open with respect to the body.

In such a printer, the fill port is exposed when the cover is open with respect to the body, and thus the fill port is accessible.

### EXAMPLE 8

In the printer according to the above-described examples, the tank unit may be screwed to the printing unit.

### BRIEF DESCRIPTION OF THE DRAWINGS

The invention will be described with reference to the accompanying drawings, wherein like numbers reference like elements.

FIG. 1 is a perspective view illustrating the main components of a printer according to an embodiment.

FIG. 2 is a perspective view illustrating the main components of the printer according to the embodiment.

FIG. 3 is a perspective view illustrating the main components of the printer according to the embodiment.

FIG. 4 is a perspective view illustrating a tank unit according to the embodiment.

FIG. 5 is an exploded perspective view illustrating a housing of the tank unit according to the embodiment.

FIG. 6 is a perspective view illustrating the main components of the printer according to the embodiment.

FIG. 7 is a perspective view illustrating the main components of the printer according to the embodiment.

FIG. 8 is a schematic cross-sectional view for explaining a problem of the well-known technique.

FIG. 9 is a schematic cross-sectional view for explaining advantages of the embodiment.

FIG. 10 is a front view illustrating the tank unit according to the embodiment.

FIG. 11 is a schematic cross-sectional view for explaining an advantage of the embodiment.

### DESCRIPTION OF EXEMPLARY EMBODIMENTS

An embodiment is described with reference to the drawings. In the drawings, the components and the members in the drawings are not necessarily to scale relative to each other so as to be recognizable.

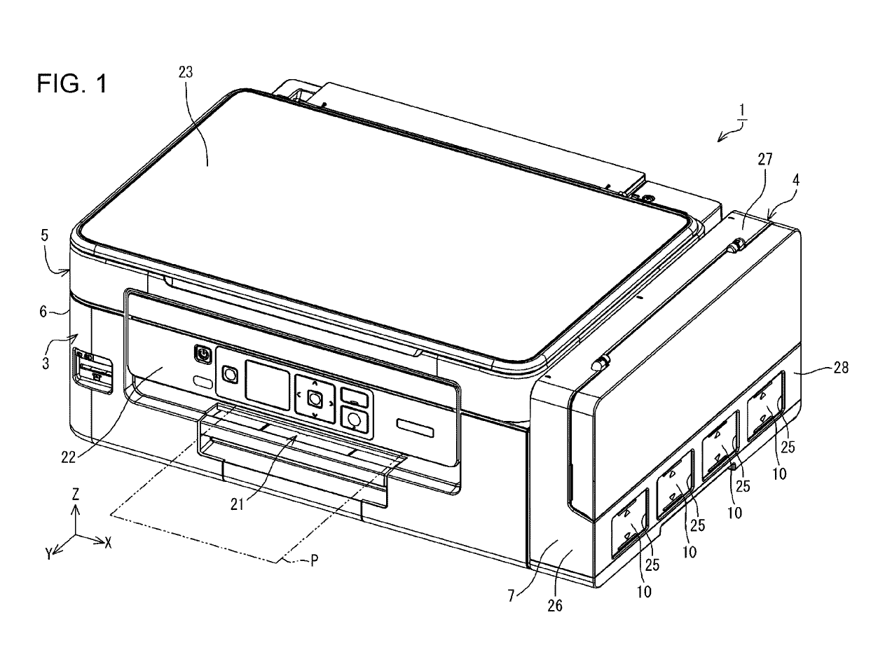

As illustrated in FIG. 1, a printer 1 according to an embodiment includes a printing unit 3, which is an example of a liquid ejecting apparatus, a tank unit 4, which is disposed on a lateral side of the printing unit 3, and a scanner 5. The printing unit 3 includes a housing 6. The housing 6 provides an outer shape of the printing unit 3. A mechanical unit, which is described later, of the printing unit 3 is housed in the housing 6. The tank unit 4 includes a housing 7 and a plurality of tanks 10 (two or more tanks 10). In this embodiment, four tanks 10 are provided. The housing 6, the housing 7, and the scanner unit 5 provide an outer shape of the printer 1. The scanner unit 5 is an optional component of the printer 1. The printer 1 performs a printing operation on a printing medium P such as a print sheet by using ink. The printing medium P is an example of a medium subjected to the printing operation.

In FIG. 1, the X, Y, and Z orthogonal coordinate axes are indicated. The X, Y, and Z axes are indicated in the other figures as needed. The X, Y, and Z axes in the other figures correspond to the X, Y, and Z axes in FIG. 1. In FIG. 1, the printer 1 is placed on an X-Y plane defined by the X axis and the Y axis. In this embodiment, the printer 1 is in an operable state of the printer 1 when placed on the X-Y plane corresponding to a horizontal plane. The printer 1 is in an operable position of the printer 1 when placed on the X-Y plane corresponding to the horizontal plane.

Hereinafter, the X, Y, and Z axes indicated or referred in the drawings and the description of the components or the unit of the printer 1 are the X, Y, and Z axes of the components or the unit that are built in (mounted in) the printer 1. The components and the unit of the printer 1 are in the operable positions of the components and the unit when the printer 1 is in the operable position of the printer 1. Hereinafter, the printer 1, the components, and the unit, for example, are described as they are in the operable position unless otherwise specified.

The Z axis is an axis perpendicular to the X-Y plane. The direction along the Z axis is a vertical direction when the printer 1 is in the operable state. In the operable state of the printer 1, the negative Z direction corresponds to a downward direction in the vertical direction in FIG. 1. The arrow directions of the X, Y, and Z axes indicate positive directions and the directions opposite the arrow directions of the X, Y, and Z axes indicate negative directions. The above-described four tanks 10 are arranged along the Y axis. The Y axis direction may be defined as a direction in which the four tanks 10 are arranged.

The printing unit 3 includes a sheet ejecting portion 21. In the printing unit 3, the printing medium P is ejected through the sheet ejecting portion 21. A side of the printing unit 3 that has the sheet ejecting portion 21 is a front surface 22. The front surface 22 of the printing unit 3 is flush with the front surface 22 of the scanner unit 5. In other words, the front surface 22 of the printer 1 includes the front surface 22 of the printing unit 3 and the front surface 22 of the scanner unit 5.

A surface of the scanner unit 5 facing upward is an upper surface 23 of the printer 1. The tank unit 4 is disposed on a lateral portion that connects the front surface 22 with the upper surface 23 and faces in the X axis direction. The housing 7 includes windows 25. The windows 25 in the housing 7 are provided in a lateral surface 28 connecting a front surface 26 with an upper surface 27. The front surface 26 of the tank unit 4 faces the same direction as the front surface 22 of the printer 1 (the Y axis direction in this embodiment). The front surface 26 of the tank unit 4 is flush with the front surface 22 of the printer 1. In other words, the front surface 26 of the tank unit 4 is flush with the front surface 22 of the printing unit 3. This configuration reduces unevenness between the printing unit 3 and the tank unit 4 in an external appearance of the printer 1, reducing the possibility that the printer 1 will come in contact with the surroundings during transportation of the printer 1, for example.

The upper surface 27 of the tank unit 4 is positioned on the positive side in the Z axis direction of the printing unit 3. In other words, the upper surface 27 of the tank unit 4 is positioned above the printing unit 3. This reduces unevenness between the printing unit 3 and the tank unit 4 in the external appearance of the printer 1, reducing the possibility that the printer 1 will come in contact with the surroundings during transportation of the printer 1, for example. In addition, in the printer 1, the ink capacity of the tank unit 4 is increased by increasing the size of the tank unit 4 in the upper direction. Thus, the size of the printer 1 is unlikely to be increased in the lateral direction (the X axis direction in this embodiment).

In the tank unit 4, the windows 25 each have optical transparency, and the four tanks 10 are disposed at positions corresponding to the windows 25. This configuration allows an operator of the printer 1 to visually check the four tanks 10 through the windows 25. In this embodiment, the windows 25 are openings in the housing 7. The operator can visually check the four tanks 10 through the windows 25, which are openings. The windows 25 are not limited to the openings and may be formed of a light transmissive material, for example.

In this embodiment, the tanks 10 each have optical transparency at least at a portion corresponding to the window 25. The operator can visually check the ink in each tank 10 through the portion of the tank 10 having optical transparency. Thus, the operator can visually check the amount of ink in each tank 10 by seeing each of the four tanks 10 through the window 25. In other words, the at least a portion of each tank 10 corresponding to the window 25 is able to be used as a visual checking portion, which enables the operator to visually check the amount of ink.

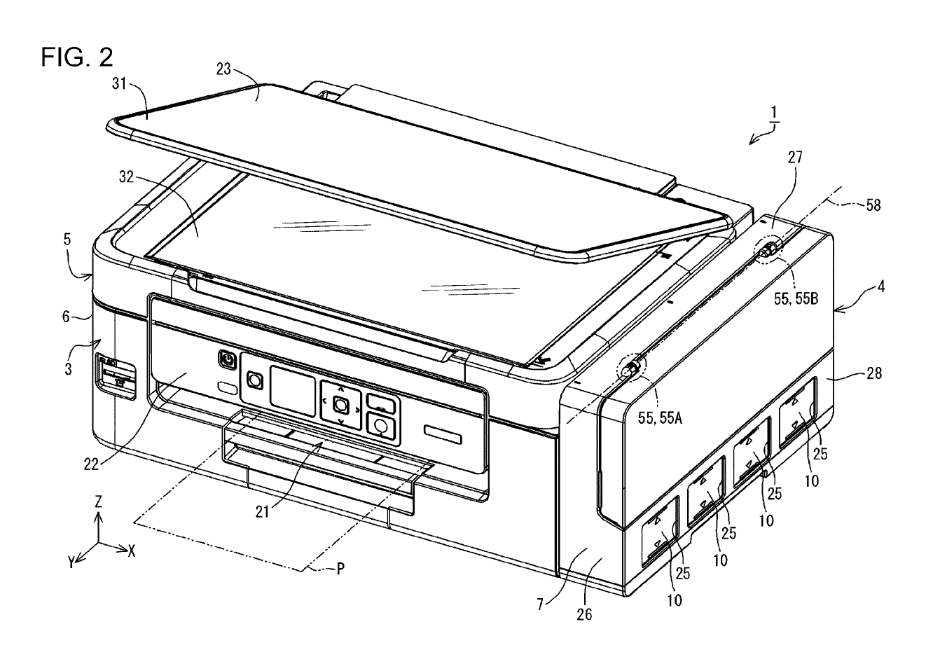

In the printer 1, the printing unit 3 and the scanner unit 5 lie on top of each other. The scanner unit 5 is disposed above the printing unit 3 in the vertical direction when the printing unit 3 is in the operable state. As illustrated in FIG. 2, the scanner unit 5, which is a flatbed type scanner, includes a document cover 31, which is pivotally opened or closed, and a document mounting surface 32, which is exposed when the document cover 31 is open. FIG. 2 illustrates a state in which the document cover 31 is open. The scanner unit 5 includes an imaging element (not illustrated) such as an image sensor. The scanner unit 5 is configured to read the image on the document such as a sheet on the document mounting surface 32 as an image data through the imagining element. Thus, the scanner unit 5 functions as a reader for images, for example.

The upper surface 27 of the tank unit 4 is located at substantially the same height as the document mounting surface 32 of the scanner 5 or is level with the document mounting surface 32 of the scanner 5 when the printer 1 is in the operable position. In some embodiments, a difference in height between the document mounting surface 32 and the upper surface 27 of the tank unit 4 in the Z axis direction is 10 mm or less to reduce the unevenness in the external appearance of the printer 1. In some embodiments, the difference in height between the document mounting surface 32 and the upper surface 27 of the tank unit 4 in the Z axis direction is 5 mm or less.

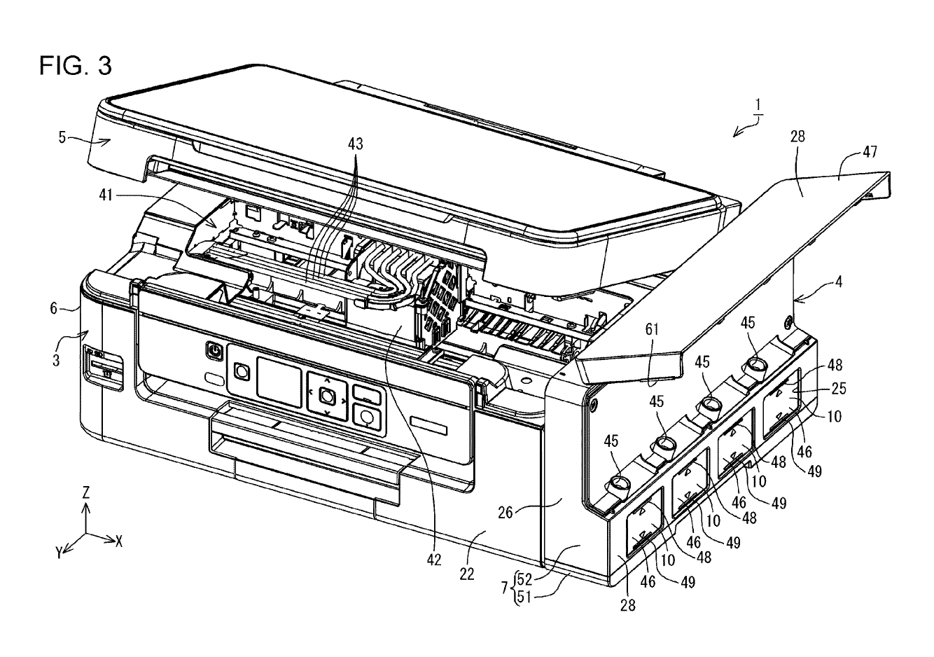

As illustrated in FIG. 3, the scanner unit 5 is pivotally movable with respect to the printing unit 3. The scanner unit 5 also functions as a cover of the printing unit 3. The operator lifts up the scanner unit 5 in the Z axis direction to turn the scanner unit 5 with respect to the printing unit 3. Thus, the scanner unit 5, which functions as a cover of the printing unit 3, is opened with respect to the printing unit 3. FIG. 3 illustrates a state in which the scanner unit 5 is open with respect to the printing unit 3.

As illustrated in FIG. 3, the printing unit 3 includes a mechanism unit 41. The mechanism unit 41 includes a printing portion 42. In the printing unit 3, the printing portion 42 is housed in the housing 6. The printing portion 42 performs a printing operation with ink on a printing medium P transported in the Y axis direction by a transportation apparatus (not illustrated). The transportation apparatus, which is not illustrated, transports the printing medium P in the Y axis direction at intervals. The printing portion 42 is configured to reciprocate along the X axis by a transfer apparatus (not illustrated). The tank unit 4 supplies ink to the printing portion 42. In the printer 1, at least a portion of the tank unit 4 protrudes outward from the housing 6. The printing portion 42 is housed in the housing 6. With this configuration, the printing portion 42 is protected by the housing 6.

Here, the direction along the X axis is not limited to a direction perfectly parallel to the X axis and includes a direction tilted by an angle error or an angle tolerance, for example, although does not include a direction perpendicular to the X axis. The direction along the Y axis is not limited to a direction perfectly parallel to the Y axis and includes a direction tilted by an angle error or an angle tolerance, for example, although does not include a direction perpendicular to the Y axis. The direction along the Z axis is not limited to a direction perfectly parallel to the Z axis and includes a direction tilted by an angle error or an angle tolerance, for example, although does not include a direction perpendicular to the Z axis. In other words, directions along predetermined axes or predetermined planes are not limited to directions perfectly parallel to the axes or the planes, and include directions tilted by an angle error or an angle tolerance, for example, although does not include directions perpendicular to the predetermined axes and planes.

The tank unit 4 includes tanks 10. In this embodiment, the tank unit 4 includes a plurality of tanks 10 (four tanks 10 in this embodiment). The tanks 10 are located outside the housing 6 of the printing unit 3. The tanks 10 are housed in the housing 7. With this configuration, the tanks 10 are protected by the housing 7. The housing 7 is located outside the housing 6. The housing 7 is screwed to the housing 6. In other words, the tank unit 4 is screwed to the printing unit 3.

In this embodiment, the tank unit 4 includes a plurality of tanks 10 (four tanks 10). However, the number of the tanks 10 is not limited to four, and may be three or smaller or four or more.

In this embodiment, the tanks 10 are separate members. However, the tank 10, which is an example of a liquid container, is not limited to this configuration. The liquid container may be one liquid container integrally including a plurality of tanks 10. In such a case, the liquid container includes a plurality of liquid holders. The liquid holders are separated from each other so as to be able to hold different kinds of liquid. This configuration enables different liquid holders to hold ink in different colors, for example.

As illustrated in FIG. 3, the tanks 10 are each connected to an ink supply tube 43. The ink in each tank 10 is supplied from the tank unit 4 to the printing portion 42 through the ink supply tube 43. The printing portion 42 includes a printing head (not illustrated). The printing head has a nozzle opening (not illustrated) facing the printing medium P. The printing head is an ink jet type printing head. The ink supplied from the tank unit 4 to the printing portion 42 through the ink supply tube 43 is supplied to the printing head. Then, the ink supplied to the printing portion 42 is ejected as ink droplets from the nozzle opening of the printing head toward the printing medium P. In the above-described example, the printing unit 3 and the tank unit 4 are separate members, but the printing unit 3 may include the tank unit 4.

The tanks 10 each include a fill port 45 and a visual checking surface 46. Ink is introduced from the outside of the tank 10 into the tank 10 through the fill port 45. The operator opens a cover 47 of the housing 7 to access the fill port 45 of the tank 10 from the outside of the housing 7. The visual checking surfaces 46 are located at positions corresponding to the windows 25. The operator visually checks the visually checking surface 46 of the tank 10 through the window 25 to visually check the amount of ink in each tank 10.

The visually checking surfaces 46 of the tank 10 each may have an upper limit mark 48 and a lower limit mark 49, for example. The operator knows the amount of ink in the tank 10 by using the upper limit mark 48 and the lower limit mark 49. The upper limit mark 48 enables the operator to notice that the ink to be poured through the fill port 45 will exceed the maximum amount and spill out of the tank 10 through the fill port 45. The lower limit mark 49 enables the operator to notice that the ink needs to be supplied. The tank 10 may include at least one of the upper limit mark 48 and the lower limit mark 49.

The housing 7 and the housing 6 may be separate members or may be an integral member. If the housing 7 and the housing 6 are an integral member, the tanks 10 are housed in the housing 6 together with the printing portion 42 and the ink supply tubes 43. If the housing 7 and the housing 6 are an integral member, the housing 6 corresponds to an exterior portion in which the liquid container and the printing head are housed.

In addition, the tanks 10 may be located at a position other than the lateral side of the housing 6 (FIG. 1) in the X axis direction. The tanks 10 may be located on the front side of the housing 6 in the Y axis direction.

In addition, in the present embodiment, the tanks 10 are separate members. However, the configuration of the tanks 10 is not limited to this configuration. The tanks 10 may be an integral tank. In such a case, one tank 10 includes a plurality of ink chambers. The ink chambers are separated from each other so as to be able to hold different kinds of ink. This configuration enables different ink chambers to hold ink in different colors, for example.

In the printer 1 having the above-described configuration, the printing head of the printing portion 42 ejects ink droplets at predetermined positions while the printing medium P is transported in the Y axis direction and the printing portion 42 is reciprocated along the X axis to perform a printing operation on the printing medium P.

The ink is not limited to any one of a water-based ink and an oil-based ink. The water-based ink may be composed of an aqueous solvent and solute such as dye dissolved in the aqueous solvent or may be composed of an aqueous dispersion medium and a dispersoid such as a pigment dispersed in the aqueous dispersion medium. The oil-based ink may be composed of an oil solvent and a solute such as dye dissolved in the oil solvent or may be composed of an oil dispersion medium and a dispersoid such as a pigment dispersed in the oil dispersion medium.

As illustrated in FIG. 3, the housing 7 of the tank unit 4 includes a first housing 51 and a second housing 52. The first housing 51 is located on the negative side in the Z axis direction of the tanks 10. The tanks 10 are supported by the first housing 51 and the housing 6. However, the supporting structure of the tank 10 is not limited to this configuration. The second housing 52 is located on the positive side in the Z axis direction of the first housing 51 and covers the tanks 10 from the positive side in the Z axis direction of the first housing 51. The tanks 10 are covered by the first and second housings 51 and 52.

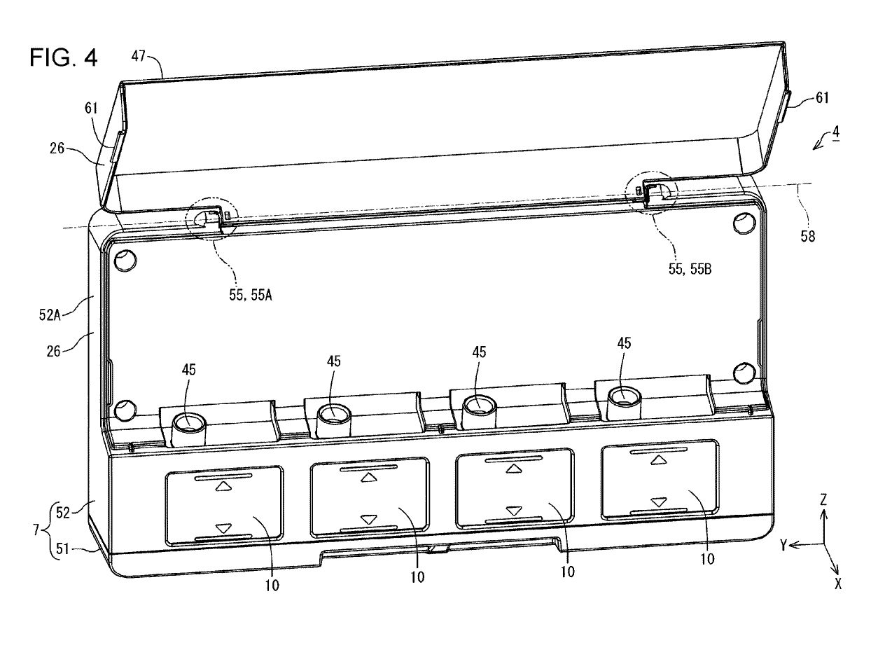

The second housing 52 includes the cover 47. The cover 47 is located on an end of the second housing 52 in the X axis direction. The cover 47 provides a portion of the lateral surface 28 facing in the X axis direction. As illustrated in FIG. 4, the cover 47 is pivotally movable with respect to a body 52A of the second housing 52. FIG. 4 illustrates a state in which the cover 47 is open with respect to the body 52A of the second housing 52. The fill ports 45 of the tanks 10 are exposed when the cover 47 is open with respect to the body 52A of the second housing 52. This allows the operator to access the fill ports 45 of the tanks 10 from the outside of the housing 7. The fill ports 45 are sealed with caps (not illustrated). The caps are removed from the fill ports 45 to open the fill ports 45 before the ink is poured into the tanks 10. In the printer 1 in the operable position, the fill ports 45 face upward with respect to the horizontal direction.

The cover 47 is turned with respect to the body 52A of the second housing 52 by a hinge 55 illustrated in FIG. 4. The hinge 55 is disposed on the upper surface 27 of the second housing 52. In this embodiment, two hinges 55 are provided. The two hinges 55 are arranged along the Y axis. Hereinafter, when the two hinges 55 need to be distinguished from each other, the two hinges 55 may be separately referred to as a hinge 55A and a hinge 55B. The hinges 55 are disposed between the cover 47 and the body 52A of the second housing 52. The hinge 55A is located on the positive side in the Y axis direction of the hinge 55B. The hinge 55A and the hinge 55B are symmetric with respect to the X-Z plane.

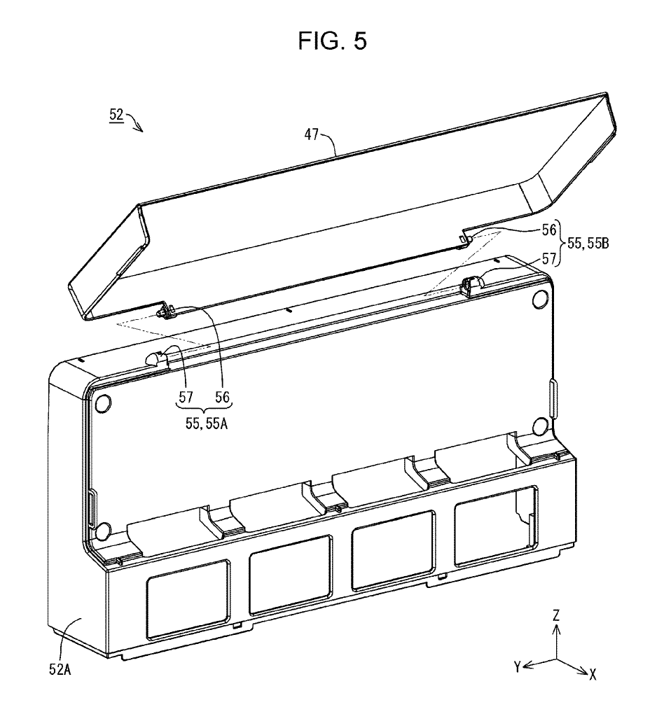

As illustrated in FIG. 5, the hinge 55 includes a hinge shaft 56 and a bearing 57. In this embodiment, the hinge shaft 56 is located on the cover 47 and the hinge bearing 57 is located on the body 52A. However, the structure of the hinge 55 is not limited to this. The hinge shaft 56 may be located on the body 52A and the bearing 57 may be located on the cover 47. The hinge shaft 56 extends along the Y axis. The hinge shaft 56 of the hinge 55A protrudes from the cover 47 in the positive Y axis direction. The hinge shaft 56 of the hinge 55B protrudes from the cover 47 in the negative Y axis direction. The bearing 57 is configured to receive the hinge shaft 56.

When the cover 47 is closed with respect to the body 52A, i.e., the printer 1 is in the operable position, the hinge shaft 56 is located at one end in the Z axis direction of the cover 47. The bearing 57 is located at the one end in the Z axis direction of the body 52A. The hinge shaft 56 of the hinge 55A is disposed in the bearing 57 of the hinge 55A. The hinge shaft 56 of the hinge 55B is disposed in the hinge shaft 57 of the hinge 55B. With this configuration, as illustrated in FIG. 4, in the second housing 52, the cover 47 is configured to turn with respect to the body 52A about a rotation axis 58. The rotation axis 58 extends along the Y axis.

In addition, the cover 47 includes tabs 61 as illustrated in FIG. 4. One of the tabs 61 is located on the front surface 26 of the tank unit 4. The other tab 61 is located on the rear surface opposite the front surface 26. In this embodiment, the tab 61 on the front surface 26 protrudes from the front surface 26 of the cover 47 in the Y axis direction. The tab 61 located on the rear surface opposite the front surface 26 of the cover 47 protrudes from the rear surface of the cover 47 in the Y axis direction.

As described above, the front surface 26 of the tank unit 4 faces the same direction as the front surface 22 (FIG. 3) of the printer 1 (the Y axis direction in the present embodiment). The front surface 22 of the printer 1 is the front surface 22 of the printing unit 3. In other words, the tab 61 on the front surface 26 of the tank unit 4 is located on a portion of the front surface 26 facing the same direction as the front surface 22 of the printing unit 3. In the tank unit 4, the tab 61 of the cover 47 enables the operator to open or close the cover 47 by holding the tab 61.

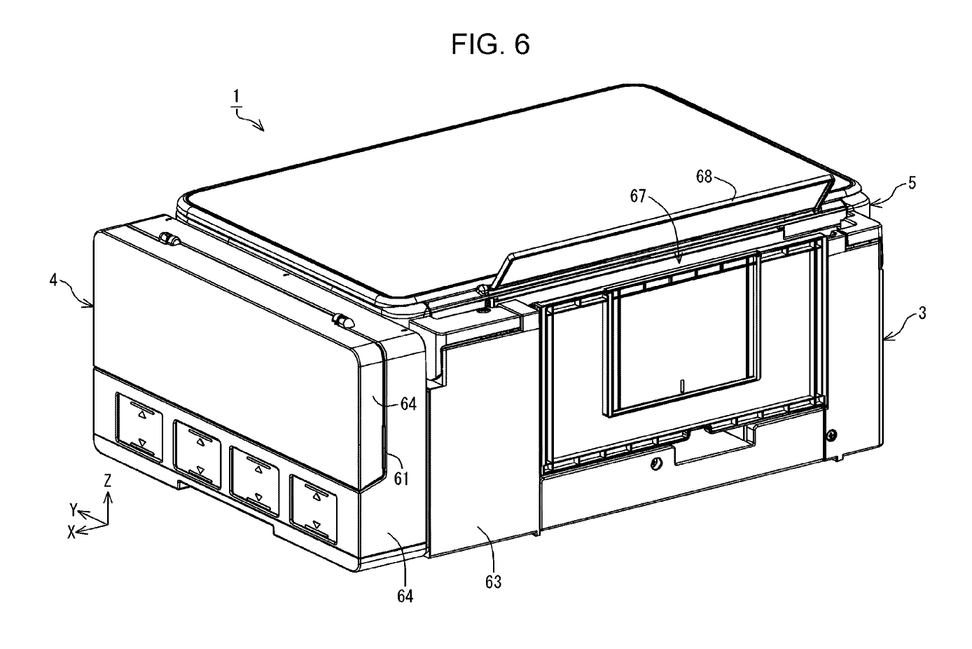

As illustrated in FIG. 6, a surface opposite the front surface 22 of the printer 1 is a rear surface 63. The rear surface 63 of the printer 1 is the rear surface 63 of the printing unit 3. The tank unit 4 has a rear surface 64 facing the same direction as the rear surface 63 of the printer 1 (the negative Y axis direction in this embodiment). The tab 61 located on the side opposite the front surface 26 (FIG. 4) is located on the rear surface 64 of the cover 47.

The rear surface 64 of the tank unit 4 faces the same direction as the rear surface 63 of the printer 1 (the negative Y axis direction in this embodiment). In this embodiment, the rear surface 64 of the tank unit 4 is flush with the rear surface 63 of the printer 1. In other words, the rear surface 64 of the tank unit 4 is flush with the rear surface 63 of the printing unit 3. This configuration reduces unevenness between the printing unit 3 and the tank unit 4 in the external appearance of the printer 1, reducing the possibility that the printer 1 will come into contact with the surroundings during transportation of the printer 1, for example.

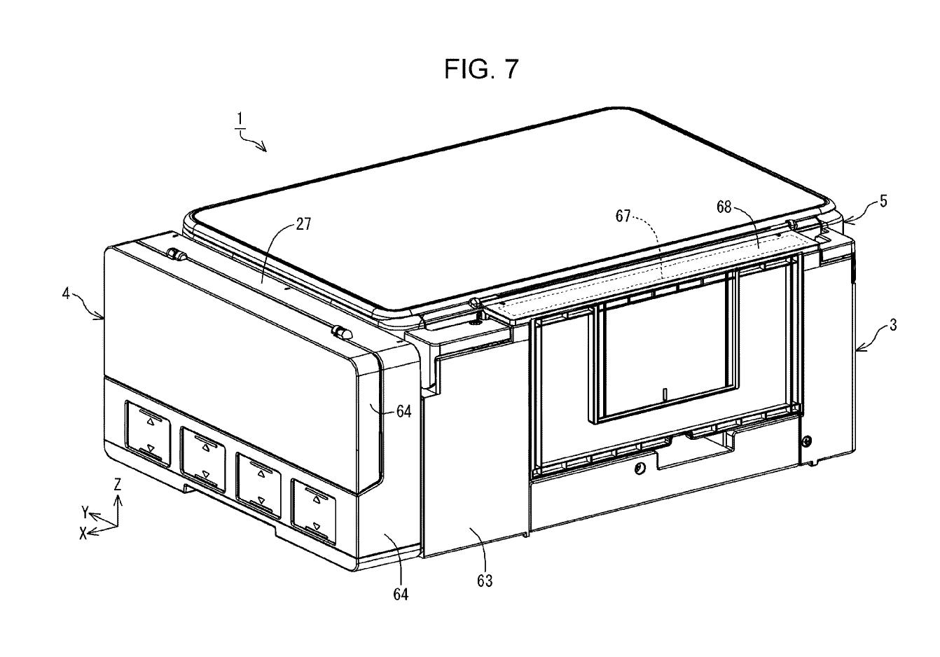

In addition, the printer 1 includes a supply opening 67 on the upper surface of the printing unit 3. The printing medium P is supplied through the supply opening 67. The printing medium P inserted into the supply opening 67 is supplied to the mechanism unit 41 (FIG. 3) of the printing unit 3. A cover 68 is disposed on the upper surface of the printing unit 3. The cover 68 is pivotally movable with respect to the printing unit 3 so as to open or close the supply opening 67. FIG. 6 illustrates a state in which the cover 68 is open with respect to the printing unit 3. The operator supplies the printing medium P to the supply opening 67 while the cover 68 is open with respect to the printing unit 3. As illustrated in FIG. 7, the cover 68 covers the supply opening 67 when the cover 68 is closed with respect to the printing unit 3. The cover 68 is located on the positive side in the Z axis direction of the supply opening 67. The cover 68 covers the supply opening 67 from the upper side, i.e., from the positive side in the Z axis direction of the supply opening 67 when the cover 68 is closed with respect to the printing unit 3.

Here, when the printer 1 is in the operable position, the upper surface 27 of the tank unit 4 is positioned at substantially the same height as the upper surface of the cover 68 while the cover 68 is closed with respect to the printing unit 3. This configuration reduces unevenness between the printing unit 3 and the tank unit 4 in the external appearance of the printer 1, reducing the possibility that the printer 1 will come in contact with the surroundings during transportation of the printer 1, for example. In some embodiments, a difference in height between the cover 68 and the upper surface 27 of the tank unit 4 in the Z axis direction is 10 mm or less to reduce the unevenness in the external appearance of the printer 1. In some embodiments, the difference in height between the cover 68 and the upper surface 27 of the tank unit 4 in the Z axis direction is 5 mm or less.

In this embodiment, when the printer 1 is in the operable position, the rotation axis 58 of the hinges 55 illustrated in FIG. 2 is positioned at substantially the same height as the document mounting surface 32 of the scanner unit 5. This configuration readily extends a range of opening turn of the cover 47 with respect to the body 52A. With this configuration, the cover 47 is unlikely to be positioned directly above the fill port 45 of the tank 10 when the cover 47 of the tank unit 4 is turned to the open position, allowing the ink to be readily poured into the fill port 45. In some embodiments, a difference in height between the document mounting surface 32 and the rotation axis 58 of the tank unit 4 in the Z axis direction is 5 mm or less to extend the range of turn. In some embodiments the difference in height between the document mounting surface 32 and the rotation axis 58 of the tank unit 4 in the Z axis direction is 2 mm or less.

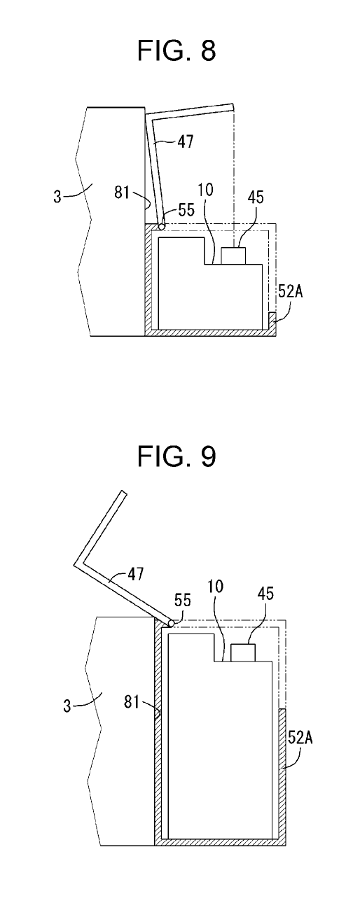

As illustrated in FIG. 8, if the rotation axis 58 is positioned below the document mounting surface 32 by more than the above-described maximum value, the cover 47 comes in contact with a side portion 81 of the printer 1 when opened, narrowing the range of turn. In this configuration, the cover 47 of the tank unit 4 may partially be positioned over the fill portion 45 of the tank 10 when turned to the open position. In such a case, the cover 47 positioned over the fill port 45 tends to interrupt ink filling.

In this embodiment, as illustrated in FIG. 9, the range of turn of the cover 47 is extended to solve the above-described problem. With this configuration, the cover 47 of the tank unit 4 is unlikely to be positioned over the fill port 45 of the tank 10 when turned to the open position.

The configuration of the printer 1 is not limited to the configuration in which the rotation axis 58 of the hinges 55 is located at substantially the same height as the document mounting surface 32 of the scanner unit 5. The rotation axis 58 of the hinges 55 may be located above the document mounting surface 32 of the scanner unit 5. The range of turn of the cover 47 is further extended if the rotation axis 58 is located above the document mounting surface 32. With this configuration, the cover 47 of the tank unit 4 is more unlikely to be positioned over the fill port 45 of the tank 10 when turned to the open position.

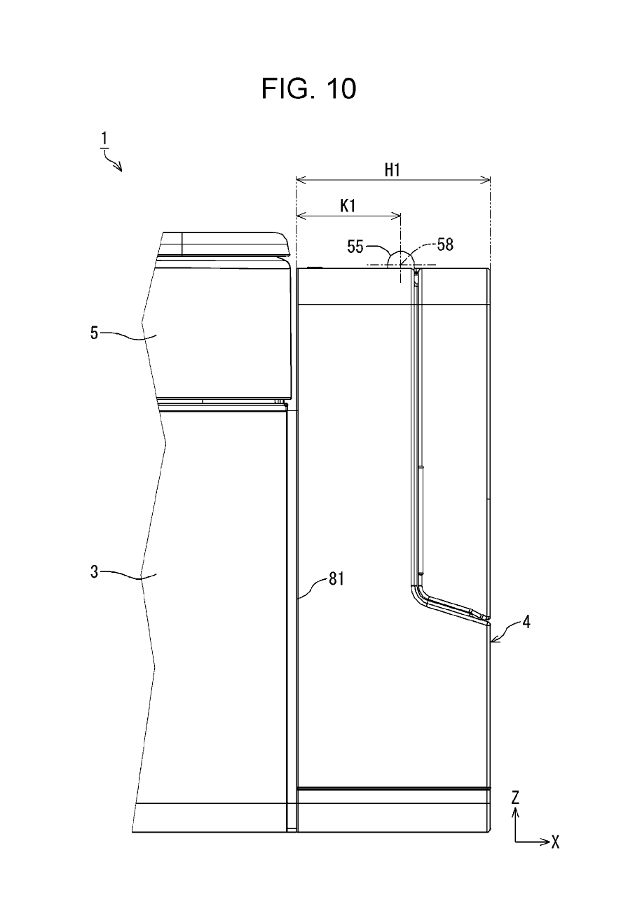

In addition, as illustrated in FIG. 10 of this embodiment, when the tank unit 4 is viewed in the negative Y axis direction, a distance K1 between an end of the housing 7 adjacent to the printing unit 3 and the hinge 55 in the X axis direction is at least half a width H1 of the tank unit 4 while the cover 47 is closed with respect to the body 52A. The state in which the tank unit 4 is viewed in the negative Y axis direction corresponds to a state in which the tank unit 4 is viewed in a direction along the rotation axis 58 of the hinges 55. In this embodiment, the X axis direction corresponds to a first direction. In other words, the X axis direction is a direction from the side portion 81 of the printing unit 3 toward the tank unit 4 in this embodiment.

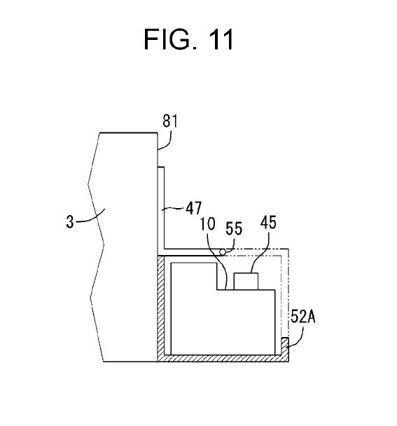

With the above-described configuration, as illustrated in FIG. 11, the cover 47 is unlikely to come in contact with the side portion 81 of the printer 1 when opened. This extends the range of turn of the cover 47 of the tank unit 4. With this configuration, the cover 47 is unlikely to be positioned over the fill port 45 of the tank 10 when turned to the open position, allowing the ink to be readily poured into the fill port 45. In this embodiment, the distance K1 is larger than the half of the width H1. This configuration further extends the range of opening turn of the cover 47 with respect to the body 52A.

In the above-described embodiments, the liquid ejecting apparatus may be a liquid ejecting apparatus which ejects, discharges, or applies liquid other than ink. In addition, the liquid discharged as a minute amount of liquid droplets from the liquid ejecting apparatus may be in a granular shape, a teardrop shape, and a thread shape leaving a trail. In addition, the liquid here may be any material that can be ejected, discharged, or applied from a liquid ejecting apparatus. For example, the material may be a material in a liquid phase. The material may be a high-viscosity or low-viscosity liquid material, a sol, gel water, an inorganic solvent, an organic solvent, a solution, a liquid resin, or a liquid metal (metal melt), for example, which flows. In addition, the state of the liquid is not limited to the liquid phase, which is one of states of the material. The liquid may include a solvent and particles of a functional material including a pigment or metal particles, which are solid materials, dissolved, dispersed, or mixed into the solvent. Representative examples of the liquid include liquid crystal, in addition to the ink in the above-described embodiments. Examples of ink include various liquid compositions such as a water-based ink, an oil-based ink, a gel ink, and a hot melt ink. In addition, the ink may be a sublimation transfer ink. The sublimation transfer ink is ink including a sublimation colorant such as a sublimation dye. Printing is performed by ejecting the sublimation transfer ink on a transfer medium by the liquid ejecting apparatus and bringing the transfer medium into contact with a material to be printed. Then, the material is heated to sublimate the colorant, and thus the colorant is transferred to the material. The material to be printed may be a T-shirt or a smart phone, for example. As described above, ink including a sublimation colorant enables printing on various materials (printing medium). Specific examples of the liquid ejecting apparatus include a liquid ejecting apparatus that ejects liquid including a material such as an electrode material, or a colorant in a dispersed state or dissolved state used in production of a liquid crystal display, an EL (electroluminescence) display, a surface emitting display, and a color filter. Examples of the liquid ejecting apparatus further include a liquid ejecting apparatus that ejects a biological organic substance which is used in production of a biochip, a liquid ejecting apparatus used as a precision pipette that ejects liquid as a sample, a textile printing device, and a micro-dispenser. In addition, the liquid ejecting apparatus may be a liquid ejecting apparatus that ejects a lubricant to a predetermined position of a precision machine such as a clock, and a camera, with high precision, or a liquid ejecting apparatus that ejects a transparent resin liquid such as a UV curable resin for forming a micro hemispherical lens (optical lens) which is used in an optical communication device, for example, onto a substrate. In addition, the liquid ejecting apparatus may be a liquid ejecting apparatus that ejects an etching liquid such as an acid etching liquid and an alkali etching liquid for etching a substrate, for example.

Here, the invention is not limited to the embodiments and examples described above, and the invention may be achieved in various configurations within the spirit of the invention. For example, the technical characteristics in the embodiments and examples, which correspond to the technical characteristics, in the aspects described in SUMMARY, may be replaced or combined as appropriate in order to solve a portion or all of the problems described above, or in order to achieve some or all of the effects described above. In addition, one or more of the technical characteristics that are not described as essential may be omitted as appropriate.

The entire disclosure of Japanese Patent Application No. 2015-251077, filed Dec. 24, 2015 is expressly incorporated by reference herein.

What is claimed is:

1. A printer comprising:
a printing unit including a printing head configured to eject ink onto a sheet and a sheet ejecting portion configured to eject the sheet after the printing head performs a printing operation;
a scanner unit located above the printing unit and configured to read an image on a document; and
a tank unit located on a lateral side of the printing unit, wherein
the tank unit includes a tank storing the ink to be supplied to the printing head and a housing covering the tank,
the housing has a plurality of surfaces, and
a front surface of the printing unit is flush with a front surface of the tank unit when the printing unit includes the front surface on a side of the sheet ejecting portion.

2. A printer comprising:
a printing unit including a printing head configured to eject ink onto a sheet and a sheet ejecting portion configured to eject the sheet after the printing head performs a printing operation;
a scanner unit located above the printing unit and configured to read an image on a document; and
a tank unit located on a lateral side of the printing unit, wherein
the tank unit includes a tank storing the ink to be supplied to the printing head and a housing covering the tank,
the housing has a plurality of surfaces, and
a rear surface of the printing unit is flush with a rear surface of the tank unit when the printing unit includes a front surface on a side of the sheet ejecting portion.

3. A printer comprising:
a printing unit including a printing head;
a scanner unit located above the printing unit and configured to read an image on a document; and
a tank unit located on a lateral side of the printing unit, wherein
the tank unit includes a tank storing the ink to be supplied to the printing head and a housing covering the tank,
the housing has a plurality of surfaces, and
an upper surface of the tank unit is located above the printing unit when the printer is in an operable position allowing the printing unit to be operated.

4. The printer according to claim 3, wherein the scanner unit has a document mounting surface on which the document is mounted, and
the upper surface of the tank unit is substantially level with the document mounting surface when the printer is in the operable position.

5. The printer according to claim 3, wherein the printing unit includes a supply opening on an upper surface of the printing unit and a cover covering the supply opening, a medium to be printed being supplied through the supply opening, and
the upper surface of the tank unit is substantially level with the cover when the printer is in the operable position.

6. The printer according to claim 1, wherein the tank includes a fill port through which the ink is poured into the tank.

7. The printer according to claim 6, wherein the housing includes:
a body covering a portion of the tank other than the fill port; and
a cover configured to be pivotally opened or closed with respect to the body, the fill port being exposed when the cover is open with respect to the body.

8. The printer according to claim 1, wherein the tank unit is screwed to the printing unit.

9. The printer according to claim 1, wherein the tank includes a plurality of tanks arranged in a direction from the front surface to a rear surface of the printing unit.

10. A printer comprising:
a printing unit including a printing head configured to eject ink onto a sheet and an ejecting portion configured to eject the sheet after the printing head performs a printing operation;
a scanner unit located above the printing unit and configured to read an image on a document; and
a tank unit disposed on a lateral side of the printing unit, wherein
the tank unit includes a tank storing the ink to be supplied to the printing head and a housing covering the tank, and
the housing has a surface extending over an entire lateral surface of each of the printing unit and the scanner unit.
